(19) United States
(12) Patent Application Publication
(10) Pub. No.: US 2006/0120616 A1
(43) Pub. Date: Jun. 8, 2006

(54) Equipment and image forming system

(75) Inventor: Koji Kita, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/183,724

(22) Filed: Jul. 18, 2005

(30) Foreign Application Priority Data
Nov. 15, 2004 (JP) 2004-330435

(51) Int. Cl. G06K 9/40

(52) U.S. Cl. 382/254

(57) ABSTRACT

A remote control system in which an equipment and a remote controller are connected with each other through a network, wherein the remote controller includes: a first display section which displays an operation screen sent from the equipment, an input section which sets an operation guide position, and a first controlling section which displays the operation screen on the first display section and sends operation guide position information corresponding to the operation guide position to the image forming apparatus, and wherein the equipment comprises: a second display section which displays a function item of the equipment, and a second controlling section which executes a server to send the operation screen displayed on the first display section to the remote controller and displays a guidance to guide an operation of the equipment on the second display section based on the operation guide position information.

### BACKGROUND OF THE INVENTION

1. Field of the Invention

The present invention relates to an equipment operated by a user such as a copier, printer facsimile and multi-function peripheral having functions thereof, and also to a remote control system which remote-controls the equipment through a network.

2. Description of Related Art

Recently, various image forming systems have been proposed, in which an image forming apparatus such as a copier, printer, facsimile and the multi function peripheral thereof, which is to output an image by forming the image on a recording medium such as paper, is connected to a remote controller such as a PC (Personal Computer) which remote-controls the image forming apparatus through a network, the remote controller sends an operation direction to operate the image forming apparatus, and an operation screen of the image forming apparatus is displayed on an operation screen of the remote controller.

For example, JP2001-306204A discloses an image processing apparatus as a user configuration sharing system, in which the image forming apparatus reads a configuration sharing file where a user configuration is described, through a recording medium or network, and an operation panel controller customizes a mode of an operation screen displayed on an operation panel according to the description of the read configuration sharing file.

Further, in an information processing apparatus disclosed in JP2000-357072A, a host computer, printer and digital copier as the information processing apparatus send or receive a device ID to authenticate a device function together with a network ID assigned in a local area network, convert an operation order to be an order of a form readable with the operating and operated device, send or receive the operation order, supplement an operation order which is not present in the operated device if the operation order at the operating device includes it, and send an image information.

Further, JP 2002-281195A discloses a remote control system of an OA equipment (office automation equipment). According to a configuration information input from the OA equipment, a remote controller displays an approximately same operation screen on a display section as a screen displayed in the OA equipment by using basic device data to display an operation screen. When an operation is input on the operation screen of the display section, the remote controller sends an operation order and screen alternation information to the OA equipment. The OA equipment works according to the operation order input from the remote controller, and the screen on the display is updated in real time according to the input alternation information input from the remote controller.

In the above systems, the image forming apparatus responds immediately to an action of the operation display section of the remote controller operated by an operator, when a user of the image forming apparatus inquires functions of the multifunctional image forming apparatus to the operator belonging to the manufacturer or various management organization or the like by a telephone. Thus, it is difficult for the user to recognize the operation performed on the operation screen, even if the user watches the operation display section of the image forming apparatus. Further, it is difficult for the operator to guide the user to operate and configure the image forming apparatus from remote location. Thus, the above systems are not user-friendly.

### SUMMARY OF THE INVENTION

The present invention is made in the light of the above problems, and one of the objects of the invention is to obtain a remote control system which is user-friendly and has superior operationality by making controlling method of an equipment being remotely guidable with an operation guide from the remote controller.

In order to achieve the above mentioned object, a first aspect of the invention is a remote control system in which an equipment and a remote controller are connected with each other through a network so as to communicate with each other, wherein the remote controller comprises: a first display section which displays an operation screen sent from the equipment, an input section which sets an operation guide position of the equipment on the operation screen displayed on the first display section, and a first controlling section which displays the operation screen on the first display section and sends operation guide position information corresponding to the operation guide position set by the input section, to the equipment, and wherein the equipment comprises: a second display section which displays the operation screen to show a function item of the equipment, and a second controlling section which executes a server to send the operation screen displayed on the first display section to the remote controller connected through the network and displays a guidance to guide an operation of the equipment at the operation screen displayed on the second display section based on the operation guide position information sent from the remote controller.

Preferably, the first controlling section displays the operation screen on the first display section by using a browser, and the second controlling section executes a web server.

Preferably, the web server executes an authentication process to authenticate the remote controller when the web server sends a screen data of the operation screen.

Preferably, the equipment further comprises: a input section which accepts an setting input by a user according to the operation screen displayed on the second display section, and the second controlling section accepts the setting input by the user at the input section while the second controlling section displays the guidance to guide an operation.

Preferably, the second controlling section displays a guide sign which guides an operation of the equipment at the operation screen displayed on the second display section according to the operation guide position information sent from the remote controller.

Preferably, the operation guide position information comprises coordinate information.

Preferably, the equipment is an image forming apparatus.

According to the second aspect of the invention, an equipment connected with a remote controller through a network so as to communicate with each other comprises: a display section which displays an operation screen to show a function item of the equipment, a input section which accepts an setting input by a user according to the operation screen displayed on the display section, and a controlling section which displays a guidance to guide an operation of the equipment at the operation screen displayed on the displaying section according to an operation guide position information received from the remote controller, and accepts the setting input by the user at the input section while the guidance to guide an operation is displayed.

Preferably, the controlling section executes a server which sends the operation screen displayed on the display section to the remote controller.

Preferably, the controlling section executes a web server.

Preferably, the web server executes an authentication process to authenticate the remote controller when the web server sends a screen data of the operation screen.

Preferably, the controlling section displays a guide sign which guides an operation of the equipment at the operation screen displayed on the display section according to the operation guide position information sent from the remote controller.

Preferably, the operation guide position information comprises coordinate information.

Preferably, the equipment is an image forming apparatus.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a constitution view of an image forming system 1 of the present embodiment;

FIG. 2 is an internal constitution view of a remote controller 10;

FIG. 3 is an internal constitution view of an image forming apparatus 20;

FIG. 4 is a flowchart of an operation guide process of the present embodiment;

FIG. 5 is one of the examples of an operation screen displayed on a display 26 of the image forming apparatus 20 at the time of step S7 shown in FIG. 4;

FIG. 6 is one of the examples of a browse operation screen displayed on a web page of a display section 15 of the remote controller 10 at the time of step S7 shown in FIG. 4;

FIG. 7 is one of the examples of a browse operation screen G10 where an operator clicks with a mouse the position of an operation key to execute the function regarding the user's inquiry; and

FIG. 8 is one of the examples of the operation screen where a guide mark MG is displayed.

### DETAILED DESCRIPTION OF PREFERRED EMBODIMENTS

As for one of embodiments of the invention, an image forming system is explained, in which an image forming apparatus comprising a WWW (World Wide Web) server (hereinafter referred to as a web server) is connected through a network to a remote controller provided with a platform where a browsing software such as a WWW (World Wide Web) browser (hereinafter referred to as a browser) runs, and the remote controller can browse and operates a web page for the remote controller provided by the web server of the image forming apparatus by using a browser.

Hereinafter, the embodiment of the present invention is explained in detail with reference to the drawings.

First, the constitution is explained.

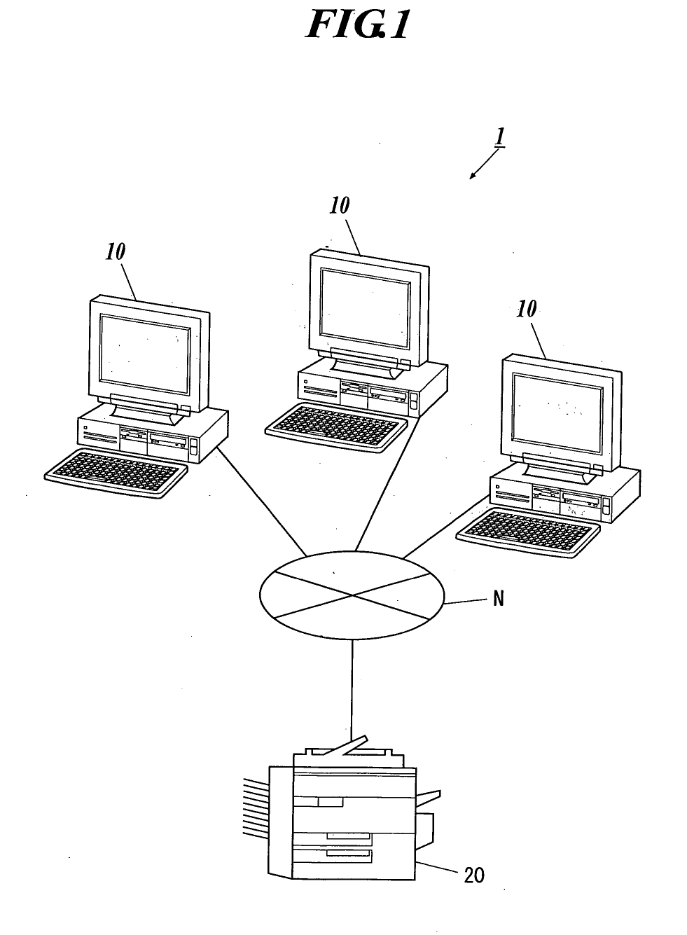

FIG. 1 shows constitution of an image forming system 1 of the present embodiment.

As shown in FIG. 1, the image forming system 1 comprises a remote controller 10 and an image forming apparatus 20, and the apparatuses are constituted so that they can send and receive information each other through a network N. FIG. 1 shows an example where three remote controllers 10 and one image forming apparatus are connected with each other. However, the number of each apparatus is not limited.

The remote controller 10 is to remote-control the image forming apparatus 20, and for example, is an apparatus to browse an operation screen of the image forming apparatus 20 by using a browser and to send an operation direction input on the operation screen to the image forming apparatus 20. For example, information processing equipment such as a general purpose PC and the like is applicable.

The image forming apparatus 20, to which software to provide a content browsed by a browser is installed, comprises an image forming function and a function as a web server, and is an apparatus to perform a process according to an operation direction from an operation member provided with the apparatus and the operation direction sent from the remote controller 10. For example, a copier, printer, facsimile, multi-function peripheral thereof and the like are applicable.

The network N may be a LAN (Local Area Network) or WAN (Wide Area Network). Further, the network N may have a constitution including a telephone line network, ISDN (Integrated Services Digital Network) line network, broadband communication network, leased line, mobile communication network, communication satellite network, CATV (Community Antenna Television) network, optical communication network and radio communication network, and an internet service provider or the like connecting them with each other,

First, the remote controller 10 is explained.

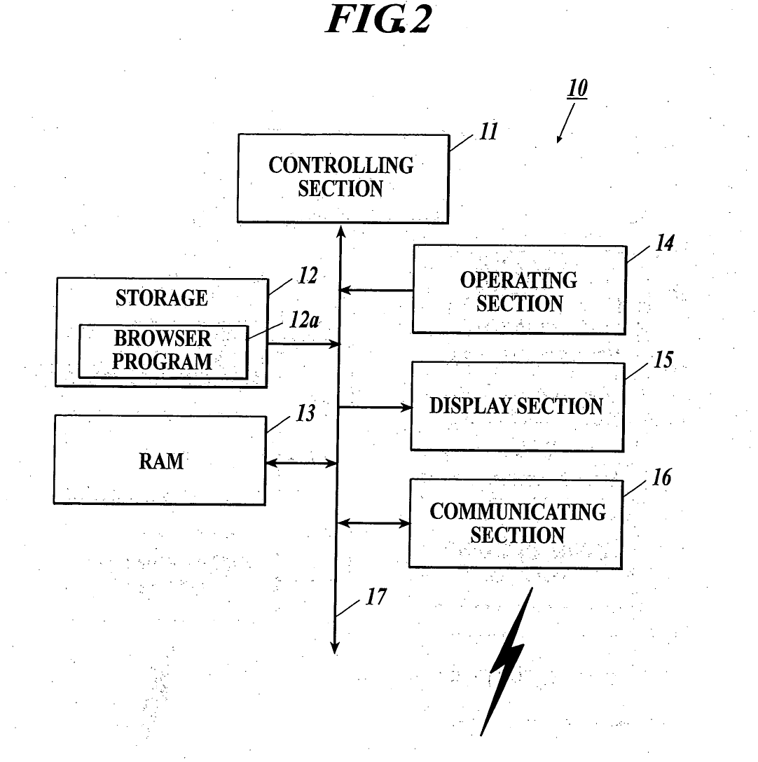

FIG. 2 shows an internal constitution of the remote controller 10.

As shown in FIG. 2, the remote controller 10 comprises a controlling section 11, storage 12, RAM (Random Access Memory) 13, operating section 14, display section 15, communicating section 16 and the like. Each of the sections are connected and can communicate with each other through a bus 17.

The controlling section 11 comprising a CPU (Central Processing Unit) and the like expands a system program, various controlling programs and various data stored in the storage 12 onto the RAM 13, and performs a centralized control of the whole operation of the remote controller in cooperation with these programs and data.

Further, the controlling section 11 displays a screen data of an operation screen on the display section 15 as a browse operation screen, the screen data received from the image forming apparatus 20 through the communicating section 16 by using a browser program 12a and various data stored in the storage 12, and sends a direction coordinates to the image forming apparatus 20, the direction coordinates corresponding to an operation guide position set by the operating section 14 on the browse operation screen.

The storage 12 comprises a nonvolatile recording medium such as a ROM (Read Only Memory), HDD (Hard Disk Drive) and the like, and stores a system program executed by the controlling section 11, various controlling programs, the browsing program 12a to execute the browser, data regarding these programs and the like in the nonvolatile recording medium.

The RAM 13 forms a work area which temporarily stores the various programs executed by the controlling section 11 and data regarding them.

The operating section 14 is constituted to include a pointing device such as a keyboard and mouse, the keyboard comprising a number key, character key, various function keys and the like to input the operation direction to the image forming apparatus 20. The operating section 14 sends an input operation signal to the controlling section 11. Further, the operating section 14 is used to set the operation guide position of the image forming apparatus 20 on the browse operation screen displayed on the display section 15.

The display section 15 is constituted to comprise a LCD (Liquid Crystal Display) and the like, and is to display various screens according to a control signal input to the controlling section 11. The display section 15 displays the data input on the operating section 14 and a screen data of an operation screen on a web page as the browse operation screen by using the browser, the operation screen sent from the image forming apparatus 20 through the communicating section 16.

The communicating section 16 is constituted to comprise various interfaces such as network interface card (NIC), modem (MOdulator-DEModulator), USB (Universal Serial Bus) and the like, and sends and receives information to and from an external device on the network N.

Next, the image forming apparatus 20 is explained.

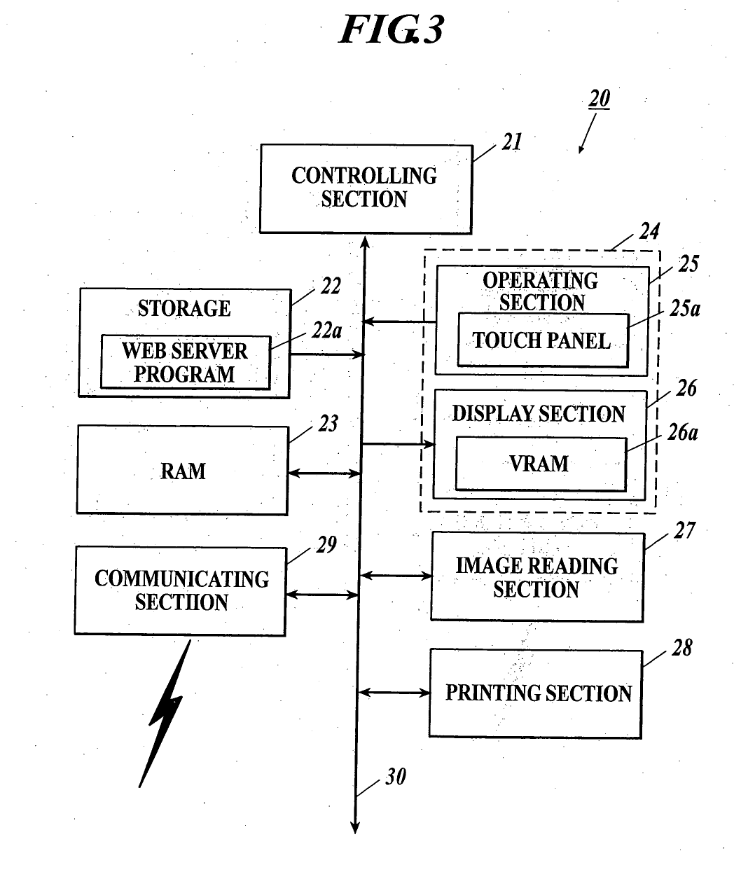

FIG. 3 shows an internal constitution of the image forming apparatus 20.

As shown in FIG. 3, the image forming apparatus 20 comprises a controlling section 21, storage 22, RAM 23, operation display section 24, image reading section 27, printing section 28 and communicating section 29, and each of the sections are connected and can communicate with each other through bus 30.

The controlling section 21 comprising a CPU and the like expands a system program, various controlling programs and various data stored in the storage 22 onto the RAM 23, and controls the overall sections constituting the image forming apparatus 20 in cooperation with these programs and data.

The controlling section 21 expands a web server program 22a stored in the storage 22 on the RAM 23 and executes a web server, and sends the web page on the web server to the remote controller 10 connected to the network N through the communicating section 29.

The web server makes the operation screen on the display section 26, which is displayed by using a markup language such as SGML (Standard Generalized Markup Language), HTML (HyperText Markup Language), TEX and the like to the browse operation screen displayed by the browser of the remote controller 10. Thus, the web server plays a role as a device which performs an image transformation to convert a screen to a screen data of PNG (Portable Network Graphics) format, stores it in the storage 22, and to send the screen data through the network N according to a request of the browser and the like of the remote controller 10.

The browse operation screen is an image having similar configuration with the operation screen displayed on the display section 26. The operation screen displayed on the display section 26 is the screen data written to a VRAM (Video Random Access Memory) 26a included in the display section 26.

The controlling section 21 executes a web server and permits the remote controller 10 to browse the operation screen displayed on the display section 26 of the image forming apparatus 20, so that the operation screen is shared with the remote controller 10. Further, the controlling section 21 performs an operation guide process to display a guide sign (hereinafter referred to as a guide mark) for directing an operation of the image forming apparatus 20 on the operation screen displayed on the display section 26 based on the directing coordinate sent from the remote controller 10 which can browse it.

The storage 22 comprises a nonvolatile recording medium such as a ROM (Read Only Memory), HDD (Hard Disk Drive) and the like, and stores a system program executed by the controlling section 21, various controlling programs, the web server program 22a to execute the web server, a program required for an image transformation process, a program required for an operation guide process, data regarding these programs and the like in this recording medium.

The RAM 23 forms a work area which temporarily stores the various programs executed by the controlling section 21 and data regarding them.

The operation display section 24 comprises an operating section 25 which accepts a selection of the various function items and a display section 26 as a second display member which displays the operation screen to show the various function items.

The operating section 25 comprises various operation hard keys such as a copy start key, numeric keypad and the like, and outputs an operation signal of the operation hard keys to the controlling section 21. Further, the operating section 25 comprises a touch panel 25a installed to cover the LCD of the display section 26, detects a coordinate of a touched position as a direction by a coordinate reading method such as an electromagnetic method, magnetostriction method and pressure-sensitive method, and outputs the detected coordinate to the controlling section 21. Further, the operating section 25 comprises a support mode release key (not shown) to terminate the remote guide process of the remote controller 10.

It is explained that the support mode release key is installed to the operating section 25 as one of the various operation hard keys. However, it is not limited thereto as long as it can accept a direction to make the remote controller 10 terminate the remote guide process. The support mode release key can be installed as an operation key included in the operation screen.

The display section 26 comprises a display such as a LCD (Liquid Crystal Display) and a VRAM 26a to temporarily store the data to display the operation screen on the display, and perform a necessary display process according to the data stored in the VRAM 26a by the controlling section 21.

The image reading section 27 is constituted to comprise a light source and an image sensor such as a CCD (Charge Coupled Device) image sensor below a contact glass, and scans by light an original mounted on the contact glass, converts the reflected light by photoelectric conversion with the CCD image sensor, and performs a digital conversion, so that image data of the original is obtained. The image data of the original is stored in the printing section 28 as printing data.

The printing section 28 comprises a sheet feeding section (not shown) to feed various kinds of recording medium, and forms an image on the designated recording medium based on the printing data which the controlling section 21 directs to print. The printing method can be any methods such as a photoelectric method, inkjet method and the like.

The communicating section 29 is constituted to comprise various interfaces such as NIC, modem, USB and the like, and sends and receives information to and from an external device on the network N.

Next, operation of the present embodiment is explained.

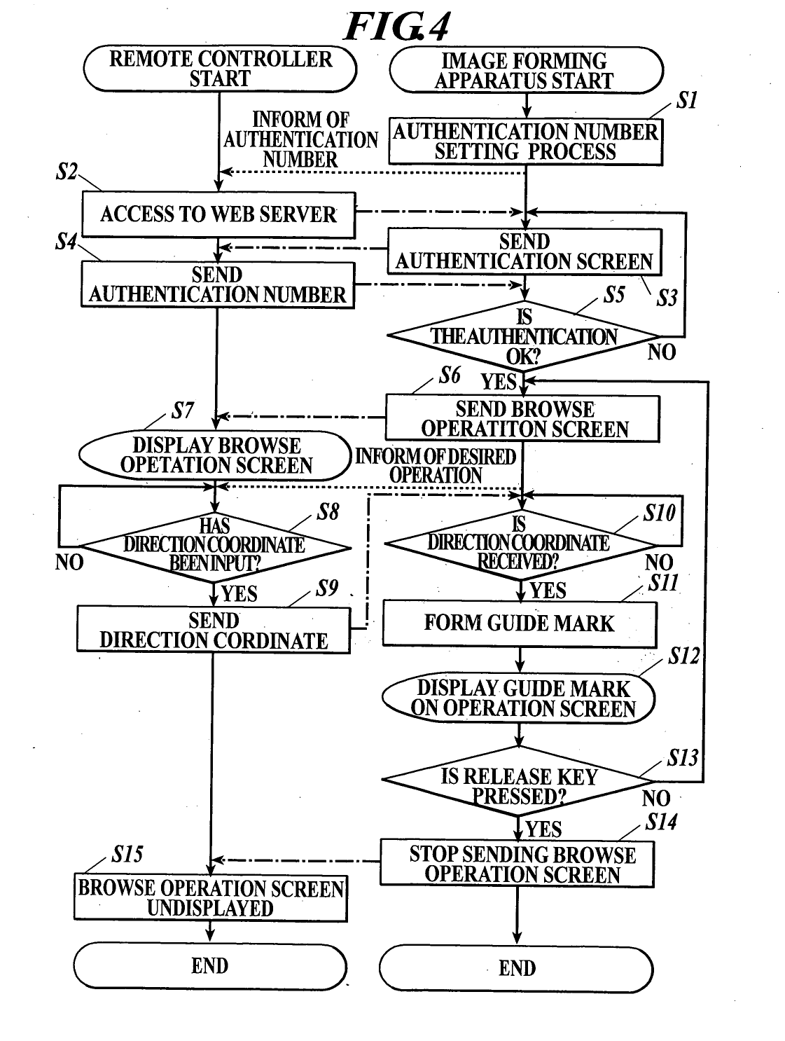

FIG. 4 shows a flowchart of the operation guide process of the present embodiment.

It is assumed that a user operating the image forming apparatus 20 inquires an operating method to a service center or the like by a telephone, and an operator of the service center guides the user in the operation by using the remote controller 10.

The controlling section 21 of the image forming apparatus 20 executes a setting process to set an authentication number by temporarily storing and retaining in the RAM 23 an authentication signal sent from the operating section 25 operated by the user as the authentication number which enables to browse the display section 26 (step S1). After the user sets the authentication number (after step S1), the user informs the operator of the set authentication number. It is preferable that the user can set the authentication number optionally.

The controlling section 11 of the remote controller 10 accesses to the web server of the image forming apparatus 20 by using the browser, according to the operation signal sent from the operating section 14 operated by the operator (step S2).

The web server executed on the controlling section 21 of the image forming apparatus 20 receives an access request of the remote controller 10, and sends screen data for authentication (step S3).

The controlling section 11 of the remote controller 10 displays the screen data for authentication received from the remote controller 10 on the display section 15 as the authentication screen by using the browser. The operator inputs the authentication number to the displayed authentication screen with the operating section 14. The controlling section 11 of the remote controller 10 sends the authentication number input from the operating section 14 to the image forming apparatus 20 (step S4).

The controlling section 21 of the image forming apparatus 20 judges whether the authentication number received from the remote controller 10 is same as the set authentication number or not (step S5). When it is found the received authentication number is different from the set authentication number (step S5; No), the controlling section 21 sends the screen data for authentication to the remote controller 10 again (back to step S3).

When the controlling section 21 of the image forming apparatus 20 finds that the received authentication number is same as the set authentication number (step S5; Yes), the web server reads out the data of the displayed operation screen displayed from the VRAM 26a of the display section 26 and sends the screen data to the remote controller 10, the screen data being the browse operation screen converted from the read data by the controlling section 21 (step S6).

The controlling section 11 of the remote controller 10 displays the screen data received by using the browser on the display section 15 as the browse operation screen (step S7).

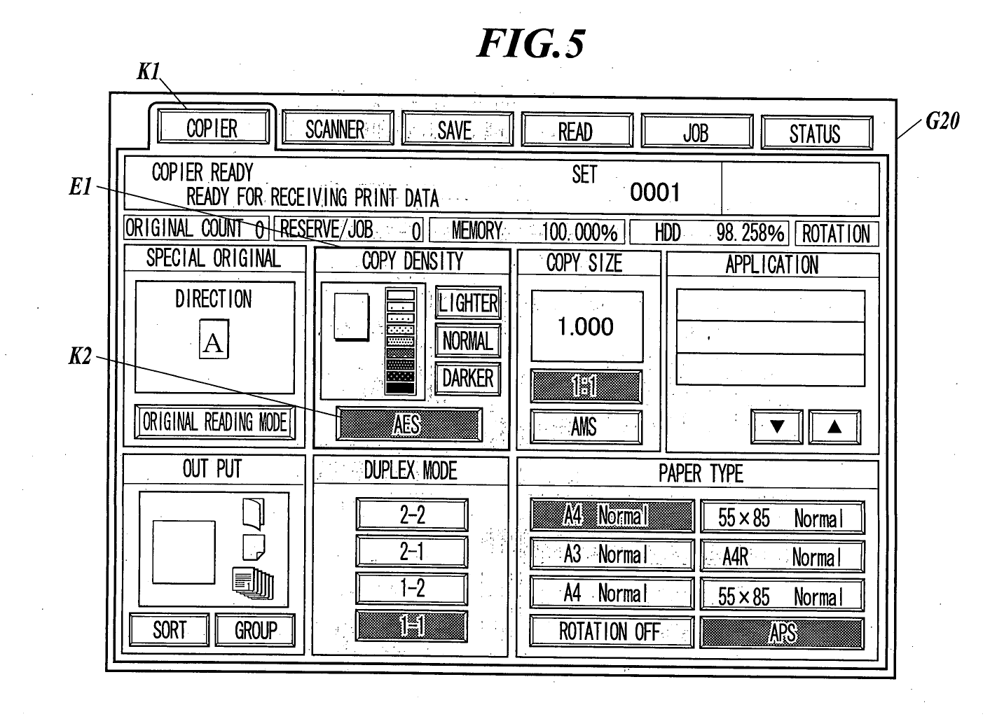

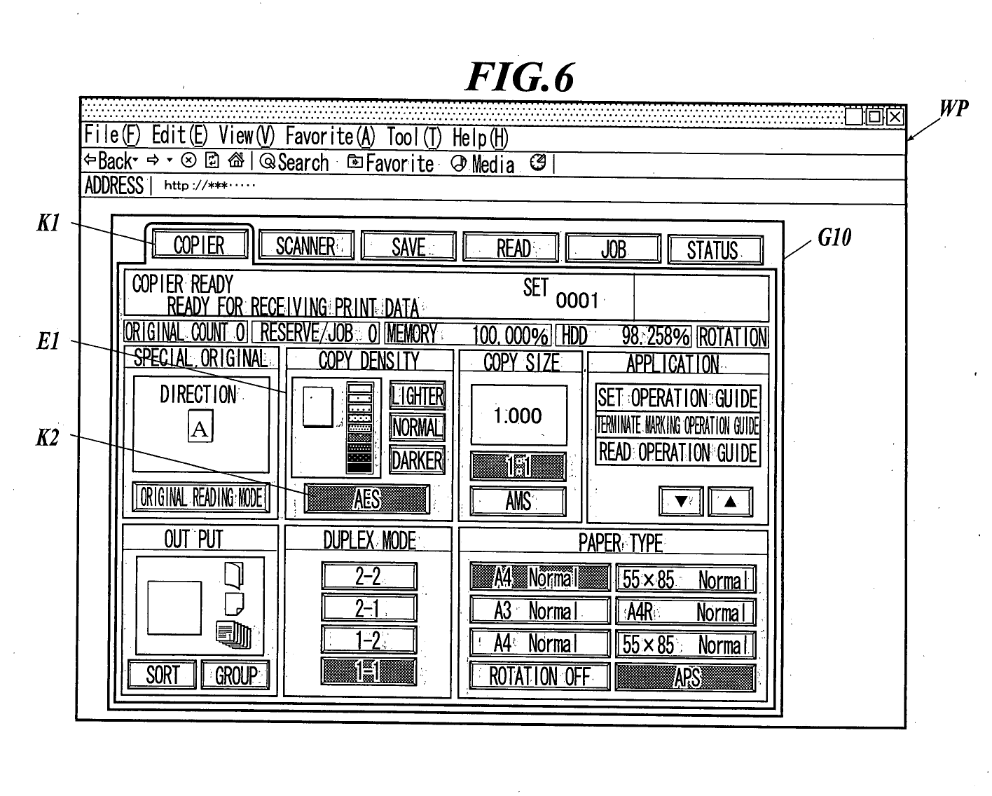

FIG. 5 shows one of the examples of the operation screen displayed on the display section 26 of the image forming apparatus 20 at the time of step S7. FIG. 6 shows one of the examples of the browse operation screen on the web page displayed on the display section 15 of the remote controller 10 at the time of step S7. In FIGS. 5 to 8, “AES”, “AMS” and “APS” respectively mean “automatic exposure selection”, “automatic magnification selection” and “automatic paper selection”.

An operation screen G20 shown in FIG. 5 includes an operation key for each of operation item areas which can use when a copy function key K1 is selected. In the operation screen G20 shown in FIG. 5, the operation key of the previously selected function item is highlighted. For example, an AES (automatic exposure selection) key K2 is highlighted at a copy density setting area E1, which shows that an image density is set automatically.

An browse operation screen G10 shown in FIG. 6 is displayed on a web page WP displayed by using the browser, and includes approximately same image as the operation screen G20 shown in FIG. 5.

Accordingly, at the time of step S7, the user on the side of the image forming apparatus 20 shares an approximately same operation screen with the operator on the side of the remote controller 10.

After the user shares the approximately same operation screen information with the operator (after step S7), the user communicates with the operator by a telephone to make inquiry.

The controlling section 11 of the remote controller 10 judges whether the operator has input from the controlling section 14 a signal (directing coordinate) corresponding to a position (operation guide position) of the operation key to execute the function regarding the user's inquiry or not (step S8). The operation to set the operation guide position is, for example, that the operator places a mouse pointer on the displayed browse operation screen G10 and clicks so as to make the clicked position being the operation guide position by using a mouse.

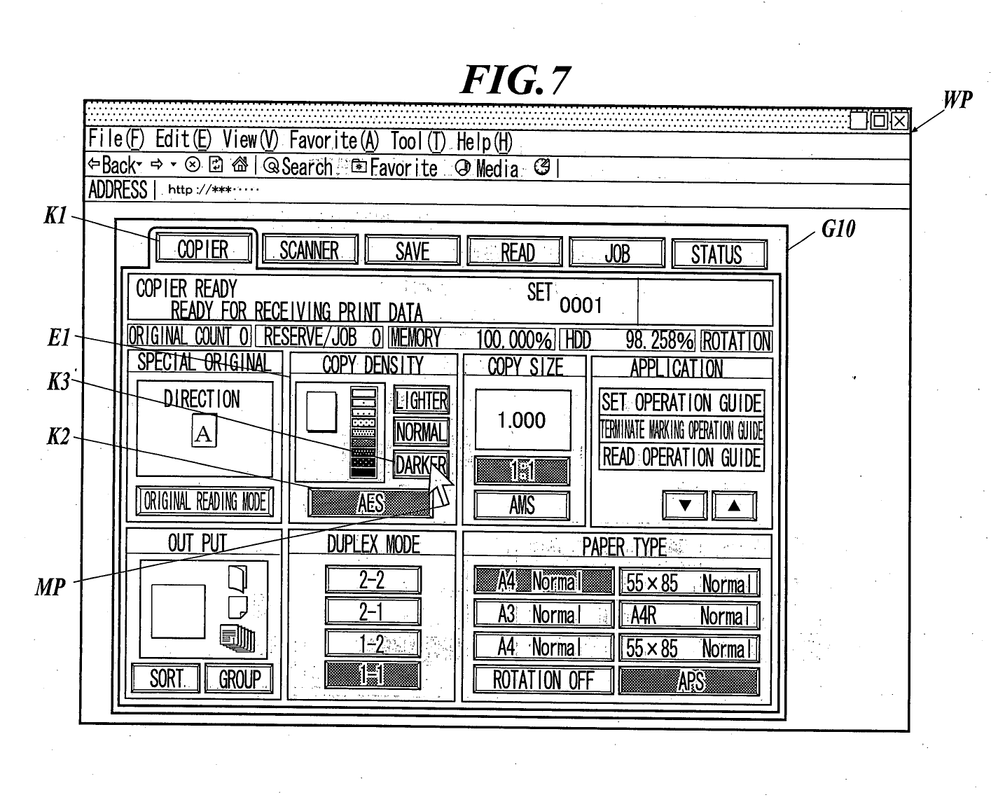

FIG. 7 shows one of the examples of the browse operation screen G10 where the operator sets a position of the operation key to execute the function regarding the user's inquiry as the operation guide position by using a mouse.

The browse operation screen G10 shown in FIG. 7 is in the state that the mouse pointer MP displayed as an arrow is placed and clicked on the “darker” key K3 shown as “darker” among three copy density keys of “lighter”, “normal” and “darker” located on a copy density setting area E1, in order to answer the user's inquiry, “I would like to make density of a printed image darker”.

FIG. 7 shows an embodiment where the operation guide position is set with a mouse. However, it is not limited thereto and the operation guide position can be set with a graphic tablet or the like. Further, an arrow-shaped sign is used as the mouse pointer MP shown in FIG. 7. However, it is not limited thereto.

When the controlling section 11 of the remote controller 10 finds that the direction coordinate has not been input (step S8; No), the remote controller 11 stands by until the direction coordinate is input.

When the controlling section 11 of the remote controller 10 finds that the direction coordinate has been input (step S8; Yes), the remote controller 11 sends the direction coordinate corresponding to the input operation guide position to the image forming apparatus 20 (step S9).

The web server of the controlling section 21 of the image forming apparatus 20 judges whether the direction coordinate has been received or not (step S10). When it is found that the direction coordinate has not been received (step S8; No), the controlling section 21 of the image forming apparatus 20 stands by until it receives the direction coordinate.

When it is found that the direction coordinate has been received (step S10; Yes), the web server of the controlling section 21 of the image forming apparatus 20 temporarily stores the received direction coordinate in the RAM 23. The controlling section 21 executes an image processing to display the guide mark on the operation screen displayed on the display section 26, the guide mark being displayed at the position of the direction coordinate stored in the RAM 23 (step S11), so that the controlling section 21 displays the guide mark on the operation screen of the display section 26 (step S12).

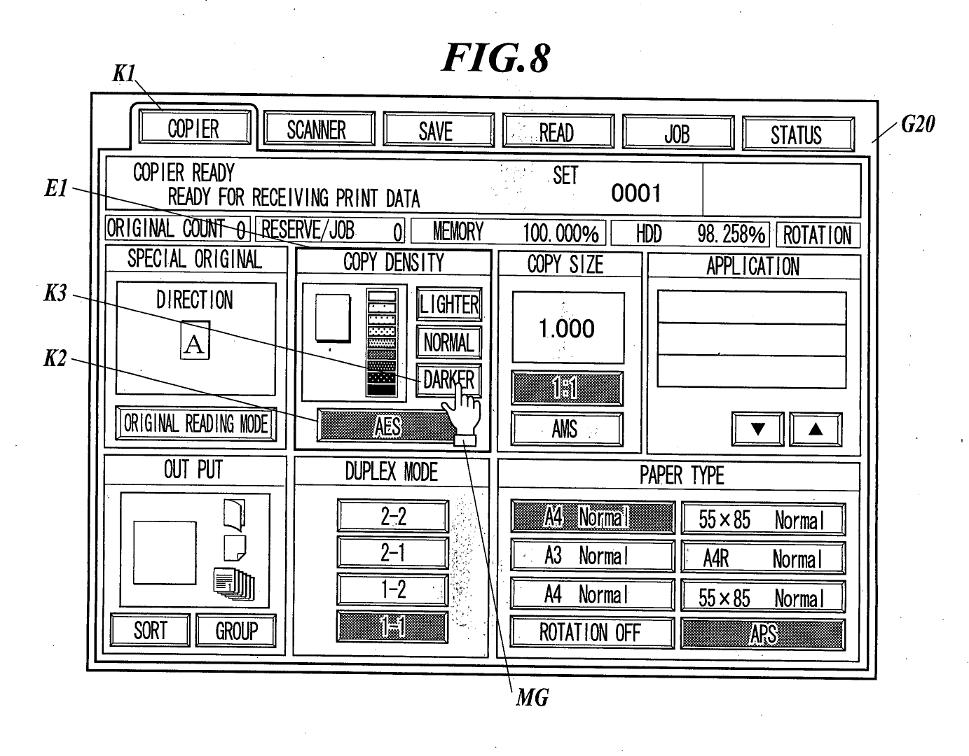

FIG. 8 shows one of the examples of the operation screen where the guide mark is displayed.

As shown in FIG. 8, the guide mark MG shown as handshape is displayed at the approximately same position as the direction coordinate corresponding to the operation guide position set by the remote controller 10, i.e. at the position of the “darker” key K3.

In FIG. 8, an indicator (sign) of handshape is used as the guide mark MG. However, it is not limited thereto.

The user figures out the position of the operation key to execute the inquired operation by looking at the operation screen G20 where the guide mark MG is displayed, and presses the operation key designated by the guide mark MG. The controlling section 21 of the image forming apparatus 20 updates the operation screen to the operation screen by which the user can execute the required function, according to the press signal of the operation key operated by the user. Along with this update of the operation screen, the web server sends the updated operation screen to the remote controller 10 as the browse operation screen. The controlling section 11 of the remote controller 10 receives the updated browse operation screen and displays the updated browse operation screen on the display section 15 by using the browser, so that the operator can judge that the user's press operation is right or wrong.

For example, when the user does not press the operation key which the guide mark MG designates properly (for example, the user presses the “lighter” key shown in FIG. 6), the browse operation screen where the “lighter” key is pressed is displayed on the display section 15 of the remote controller 10. By looking at this browse operation screen, the operator finds that the user has pressed the “lighter” key. Thus, the operator can figure out user's operation mistake by informing the user of that by a telephone or the like. The operator sets the position of the operation key on the browse operation screen again in order to guide the user to the correct operation key. Then, the guide mark MG is displayed on the operation screen of the display section 26 of the image forming apparatus 20 at the position which has set again, so that the user can figure out the position of the operation key.

It is preferable that the direction coordinate which has been set on the browse operation screen by the operator and the coordinate of the operation key which the user has been pressed by the user are displayed on the web page WP of the operator's side.

When the user does not need the remote guide of the operator, such as in the case where the user has executed the operation which the user inquired to the operator, the user presses the support mode release key.

The controlling section 21 of the image forming apparatus 20 judges whether the support mode release key of the controlling section 25 has been pressed or not (step S13). When it is judged that the support mode release key has not been pressed (step S13; No), the controlling section 21 of the image forming apparatus 20 sends the screen data of the operation screen displayed on the display section 26 (back to step S6).

When the controlling section 21 of the image forming apparatus 20 judges that the support mode release key has pressed (step S13; Yes), the web server stops the transmitting of the screen data of the operation screen displayed on the display section 26, forbids browsing the operation screen displayed on the display section 26 (step S14) and terminates the operation guide process.

The controlling section 11 of the remote controller 10 receives a browsing prohibit signal of the operation screen, so that the browse operation screen on the web page WP is made to be undisplayed (step S15).

As described above, the present invention is successful in sharing the operation screen displayed on the image forming apparatus 20 with the remote controller 10 and displaying on the operation screen the position of the operation key as guidance from the remote controller 10, the operation key by which the user can execute the desired function. Thus, it becomes possible to obtain an image forming system which is user-friendly and has superior operationality, in which the image forming apparatus being remotely guidable with an operation guide from the remote controller. Further, since the permission to browse the operation screen of the image forming apparatus 20 is performed with the authentication number, unspecified user is prevented from browsing the operation screen of the image forming apparatus 20. Thus, it becomes possible to ensure the security of the image forming system.

In the above embodiment, the guide mark is displayed on the display section 26 of the image forming apparatus 20. However, an embodiment to display guidance is not limited to the guide mark. For example, it is possible to make an operation key highlighted or blink corresponding to the operation guide position to display guidance. In such a case, the controlling section 21 of the image forming apparatus 20 may judge which key on the operation screen a received direction coordinate as a operation guidance directs to, and make the appropriate operation key highlighted or blink on the display section 26.

The present invention is not limited to the above embodiment, and various changes and modifications will be apparent to those skilled in the art. Therefore, unless otherwise such changes and modifications depart from the scope of the present invention, they should be construed as being included therein.

What is claimed is:

1. A remote control system in which an equipment and a remote controller are connected with each other through a network so as to communicate with each other,
wherein the remote controller comprises:
a first display section which displays an operation screen sent from the equipment,
an input section which sets an operation guide position of the equipment on the operation screen displayed on the first display section, and
a first controlling section which displays the operation screen on the first display section and sends operation guide position information corresponding to the operation guide position set by the input section, to the equipment, and
wherein the equipment comprises:
a second display section which displays the operation screen to show a function item of the equipment, and
a second controlling section which executes a server to send the operation screen displayed on the first display section to the remote controller connected through the network and displays a guidance to guide an operation of the equipment at the operation screen displayed on the second display section based on the operation guide position information sent from the remote controller.

2. The remote control system of claim 1,
wherein the first controlling section displays the operation screen on the first display section by using a browser, and
the second controlling section executes a web server.

3. The remote control system of claim 2,
wherein the web server executes an authentication process to authenticate the remote controller when the web server sends a screen data of the operation screen.

4. The remote control system of claim 1,
wherein the equipment further comprises:
a input section which accepts an setting input by a user according to the operation screen displayed on the second display section, and
the second controlling section accepts the setting input by the user at the input section while the second controlling section displays the guidance to guide an operation.

5. The remote control system of claim 1,
wherein the second controlling section displays a guide sign which guides an operation of the equipment at the operation screen displayed on the second display section according to the operation guide position information sent from the remote controller.

6. The remote control system of claim 1,
wherein the operation guide position information comprises coordinate information.

7. The remote control system of claim 1,
wherein the equipment is an image forming apparatus.

8. An equipment connected with a remote controller through a network so as to communicate with each other, said equipment comprising:
a display section which displays an operation screen to show a function item of the equipment,
a input section which accepts an setting input by a user according to the operation screen displayed on the display section, and
a controlling section which displays a guidance to guide an operation of the equipment at the operation screen displayed on the displaying section according to an operation guide position information received from the remote controller, and accepts the setting input by the user at the input section while the guidance to guide an operation is displayed.

9. The equipment of claim 8,
wherein the controlling section executes a server which sends the operation screen displayed on the display section to the remote controller.

10. The equipment of claim 8,
wherein the controlling section executes a web server.

11. The equipment of claim 10,
wherein the web server executes an authentication process to authenticate the remote controller when the web server sends a screen data of the operation screen.

12. The equipment of claim 8,
wherein the controlling section displays a guide sign which guides an operation of the equipment at the operation screen displayed on the display section according to the operation guide position information sent from the remote controller.

13. The equipment of claim 8,
wherein the operation guide position information comprises coordinate information.

14. The equipment of claim 8,
wherein the equipment is an image forming apparatus.
